(19) United States
(12) Patent Application Publication
(10) Pub. No.: US 2025/0136106 A1
(43) Pub. Date: May 1, 2025

(54) CARRIAGEWAY CHOPPING ALGORITHMS

(71) Applicant: TOYOTA JIDOSHA KABUSHIKI KAISHA, TOYOTA-SHI (JP)

(72) Inventor: DAVID BOYLE, Falls Church, VA (US)

(21) Appl. No.: 18/495,729

(22) Filed: Oct. 26, 2023

(51) Int. Cl. B60W 30/12

(52) U.S. Cl. CPC B60W 30/12; B60W 2552/53

(57) ABSTRACT

Systems and methods are provided for performing carriageway chopping in a mapping structure using algorithms to select a lane connector of a first lane of a carriageway. The lane connector may be evaluated to determine a face and a heading of the lane connector. The heading and face of the lane connector may be used to determine a candidate slice of the lane connector. The systems and method may determine a second candidate slice of a second lane connector of a second lane of the carriageway wherein the second lane connector is adjacent to the lane connector. The systems and method may align the candidate slices of adjacent lane connectors when the candidate slices are within a distance threshold of each other. The systems and method may chop the carriageway at the aligned candidate slices to generate carriageway links between two chops of the carriageway.

### TECHNICAL FIELD

The present disclosure relates generally to the field of road mapping, and more particularly, some applications relate to systems and methods to generate chopped carriageways with improved accuracy.

### DESCRIPTION OF RELATED ART

A carriageway generally refers to a width of road on which a vehicle is not restricted by any physical barriers to move laterally. Generally, a carriageway consists of a number of traffic lanes together with any associated shoulder. A carriageway may also be a sole lane in width, such as a highway offramp or onramp.

Carriageways may be used as a means for the public to have a right of way for passage of vehicles, such as automobiles, trucks, motorcycles, bicycles, scooters, mopeds, recreational vehicles and other like on- or off-road vehicles. It can be important for carriageways to be accurately evaluated, constructed and repaired to ensure the public has adequate and safe means of travel. Mapping systems may be used to evaluate, map, construct and repair carriageways. However, current programs of mapping systems have difficulty with accurately evaluating carriageways which may cause issues with the mapping, construction and repair of carriageways.

### BRIEF SUMMARY OF THE DISCLOSURE

According to various aspects of the disclosed technology, systems and methods for accurately evaluating and chopping carriageways of various configurations using algorithms are provided.

In accordance with some implementations, a method for carriageway chopping in mapping structures is provided. The method may include: determining a face of a lane connector of a first lane of a carriageway; determining a heading of the lane connector at the face; determining a candidate slice to the lane connector at the face; determining a second candidate slice to a second lane connector of a second lane at a second facer; aligning the candidate slice of the lane connector and the second candidate slice of the second lane connector; and chopping the carriageway at the aligned candidate slices.

In some applications, the lane connector may include a merging lane, a branching lane, an off ramp lane, an on ramp lane, a straight lane, a parking lane and a turning lane.

In some applications, the determining the face of the lane connector may include: determining a type of the lane connector; and determining the face of the lane connector according to the type.

In some applications, the type of the lane connector may include branch left, branch right, left, right, merge left, merge right, loop, loop entry, loop exit, straight and u-turn.

In some applications, the heading of the lane connector at the face is indicative of the direction of traffic at the end of the lane connector.

In some applications, the aligning the candidate slice of the lane connector and the second candidate slice of the second lane connector may include: determining a longitudinal distance between the second candidate slice to the second lane connector and the candidate slice to the lane connector; determining the longitudinal distance is within a distance threshold; and aligning the candidate slices of the lane connectors by moving the face of the lane connector or the second face of the second lane connector to position the heading of each lane connector in the same direction and the candidate slice of each lane connector on the same latitudinal line across the carriageway.

In some applications, the method may further include: generating a carriageway link between two chops of the carriageway, wherein the carriageway link between the two chops includes a consistent number of lanes of the carriageway throughout.

In some applications, the candidate slice is perpendicular to the heading of the lane connector.

In some applications, the second lane connector of the second lane is adjacent to the lane connector of the first lane of the carriageway.

In another aspect, a system for carriageway chopping in mapping structures is provided that may include one or more processors; and memory coupled to the one or more processors to store instructions, which when executed by the one or more processors, cause the one or more processors to perform operations. The operations may include: determining a face of a lane connector of a first lane of a carriageway; determining a heading of the lane connector at the face; determining a candidate slice to the lane connector at the face; determining a second candidate slice to a second lane connector of a second lane at a second face; aligning the candidate slice of the lane connector and the second candidate slice of the second lane connector; and chopping the carriageway at the aligned candidate slices.

In some applications, the lane connector may include a merging lane, a branching lane, an off ramp lane, an on ramp lane, a straight lane, a parking lane and a turning lane.

In some applications, the determining the face of the lane connector may include: determining a type of the lane connector; and determining the face of the lane connector according to the type.

In some applications, the type of the lane connector may include branch left, branch right, left, right, merge left, merge right, loop, loop entry, loop exit, straight and u-turn.

In some applications, the heading of the lane connector at the face is indicative of the direction of traffic at the end of the lane connector.

In some applications, the aligning the candidate slice of the lane connector and the second candidate slice of the second lane connector may include: determining a longitudinal distance between the second candidate slice to the second lane connector and the candidate slice to the lane connector; determining the longitudinal distance is within a distance threshold; and aligning the candidate slices of the lane connectors by moving the face of the lane connector or the second face of the second lane connector to position the heading of each lane connector in the same direction and the candidate slice of each lane connector on the same latitudinal line across the carriageway.

In some applications, the system may further include operations comprising: generating a carriageway link between two chops of the carriageway, wherein the carriageway link between the two chops includes a consistent number of lanes of the carriageway throughout.

In some applications, the candidate slice is perpendicular to the heading of the lane connector.

In some applications, the second lane connector of the second lane is adjacent to the lane connector of the first lane of the carriageway.

In another aspect, a non-transitory machine-readable medium is provided. The non-transitory computer-readable medium includes instructions that when executed by a processor may cause the processor to perform operations including: determining a face of a lane connector of a first lane of a carriageway; determining a heading of the lane connector at the face; determining a candidate slice to the lane connector at the face; determining a second candidate slice to a second lane connector of a second lane at a second face; aligning the candidate slice of the lane connector and the second candidate slice of the second lane connector; and chopping the carriageway at the aligned candidate slices.

In some applications, the lane connector may include a merging lane, a branching lane, an off ramp lane, an on ramp lane, a straight lane, a parking lane and a turning lane.

In some applications, the determining the face of the lane connector may include: determining a type of the lane connector; and determining the face of the lane connector according to the type.

In some applications, the type of the lane connector may include branch left, branch right, left, right, merge left, merge right, loop, loop entry, loop exit, straight and u-turn.

In some applications, the heading of the lane connector at the face is indicative of the direction of traffic at the end of the lane connector.

In some applications, the aligning the candidate slice of the lane connector and the second candidate slice of the second lane connector may include: determining a longitudinal distance between the second candidate slice to the second lane connector and the candidate slice to the lane connector; determining the longitudinal distance is within a distance threshold; and aligning the candidate slices of the lane connectors by moving the face of the lane connector or the second face of the second lane connector to position the heading of each lane connector in the same direction and the candidate slice of each lane connector on the same latitudinal line across the carriageway.

In some applications, the non-transitory machine-readable medium may further include operations comprising: generating a carriageway link between two chops of the carriageway, wherein the carriageway link between the two chops includes a consistent number of lanes of the carriageway throughout.

In some applications, the candidate slice is perpendicular to the heading of the lane connector.

In some applications, the second lane connector of the second lane is adjacent to the lane connector of the first lane of the carriageway.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 is an example illustration of a computing system that performs carriageway chopping in mapping structures, according to example applications described in the present disclosure.

FIG. 2 is an example illustration of a mapping structure of carriageways, according to example applications described in the present disclosure.

FIG. 3 is an example illustration of carriageway chopping in a mapping structure of carriageways, according to example applications described in the present disclosure.

FIGS. 4A and 4B are an example illustration of carriageway chopping in a mapping structure of carriageways, according to example applications described in the present disclosure.

FIG. 5 is an example illustration of a computing component that includes one or more hardware processors and machine-readable storage media storing a set of machine-readable/machine-executable instructions that, when executed, cause the one or more hardware processors to perform an illustrative method of performing carriageway chopping, according to example applications described in the present disclosure.

FIG. 6 is an example illustration of a computing component that may be used to implement various features of applications described in the present disclosure.

The figures are not exhaustive and do not limit the present disclosure to the precise form disclosed.

### DETAILED DESCRIPTION

As described above, carriageways are used as a means for the public to have a right of way for passage of vehicles, such as automobiles, trucks, motorcycles, bicycles, scooters, mopeds, recreational vehicles and other like on- or off-road vehicles. It may be important for carriageways to be accurately evaluated, constructed and repaired to ensure the public has adequate and safe means of travel. While mapping systems may be used to evaluate, map, construct and repair carriageways, current programs of mapping systems are not equipped to accurately evaluate carriageways, which may cause issues with the mapping, construction and repair of carriageways.

Aspects of the technology disclosed herein may provide systems and methods configured to accurately evaluate carriageways of various configurations using algorithms in a heuristic approach. A mapping structure system may use algorithms to accurately determine the components of a carriageway, which may be used to accurately evaluate the carriageway to perform accurate mapping, construction and repair of the carriageway. In particular, aspects of the systems and methods disclosed herein may be configured to determine components of a carriageway, such as lane connectors, faces, headings and candidate slices, to performing chopping of the carriageway into carriageway links.

A carriageway may include one or more lanes, with the lanes separated by lane markings. A lane of a carriageway may include a traffic lane, a parking lane, an emergency stopping lane, a passing lane and other lane type. A traffic lane is generally a lane within which vehicular traffic may travel in a single line in the same direction, including a straight lane, a merging lane, a branching lane, an off ramp lane, an on ramp lane, a turning lane and so on. Each lane of a carriageway may include a number of lane connectors, with each lane connector of a particular lane representing a different section of the particular lane of the carriageway. Each lane connector of a lane of a carriageway may be one of a plurality of types of lane connectors, such as straight, branch left, branch right, left, right, merge left, merge right, loop, loop entry, loop exit and u-turn. The type of a lane connector may be based on the shape and direction of traffic of the lane connector with respect to other lanes and lane connectors around the same area of the carriageway. The type of a lane connector may be based on whether its respective lane is a straight lane, a merging lane, a branching lane, an off ramp lane, an on ramp lane, a turning lane, a parking lane, an emergency stopping lane, a passing lane or other lane type.

Each lane connector may include a face. The face of a lane connector may be a line that separates the end of the first lane connector and the beginning of a second, proceeding lane connector of a particular lane of the carriageway. Lanes of a carriageway may be adjacent to each other and lane connectors of adjacent lanes may also be adjacent to each other. Lane connectors of adjacent lanes of a carriageway may be adjacent when the longitudinal distance between the faces of the respective lane connectors are within close proximity of each other. Close proximity may be when the distance between two objects are within a distance threshold, where the distance threshold may be preset, or may vary according to input data received or data corresponding to the configuration and components of the carriageway.

A lane connector may include a heading that indicates the direction of traffic that the end of the respective lane connector is directed towards. The heading of a lane connector may be determined according to the direction of traffic at the face of the lane connector. The heading of a lane connector may point towards the face of the lane connector. The direction of traffic at the face of a lane connector may be based on the type of the lane connector. The heading of a lane connector of a lane may be used to determine a candidate slice of the lane at the face of the lane connector.

A candidate slice of a lane of a carriageway may be a line that goes through the entire lane at a face of a lane connector. A candidate slice may be determined at each face of each lane connector of each lane of a carriageway. Each lane of a carriageway may include one or more candidate slices. When lane connectors have respective candidate slices that are positioned along the same latitudinal axis across the carriageway, such candidate slices may be combined to a finalized candidate slice for simplicity purposes. Each finalized candidate slice across the carriageway may be used as a marker of where the carriageway may be chopped to sectionalize the carriageway and create one or more carriageway links. A carriageway link may be a section of a carriageway between two chops of the carriageway made at two finalized candidate slices. Carriageway links may be used to accurately perform the mapping, construction and repair of a carriageway as a whole by evaluating each carriageway link individually.

The mapping system may display the mapping structure of a carriageway on a Graphical User Interface (GUI). Each component of the carriageway, including lanes, lane components, faces, headings, candidate slices, and carriageway links, may be displayed on the GUI for viewing.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

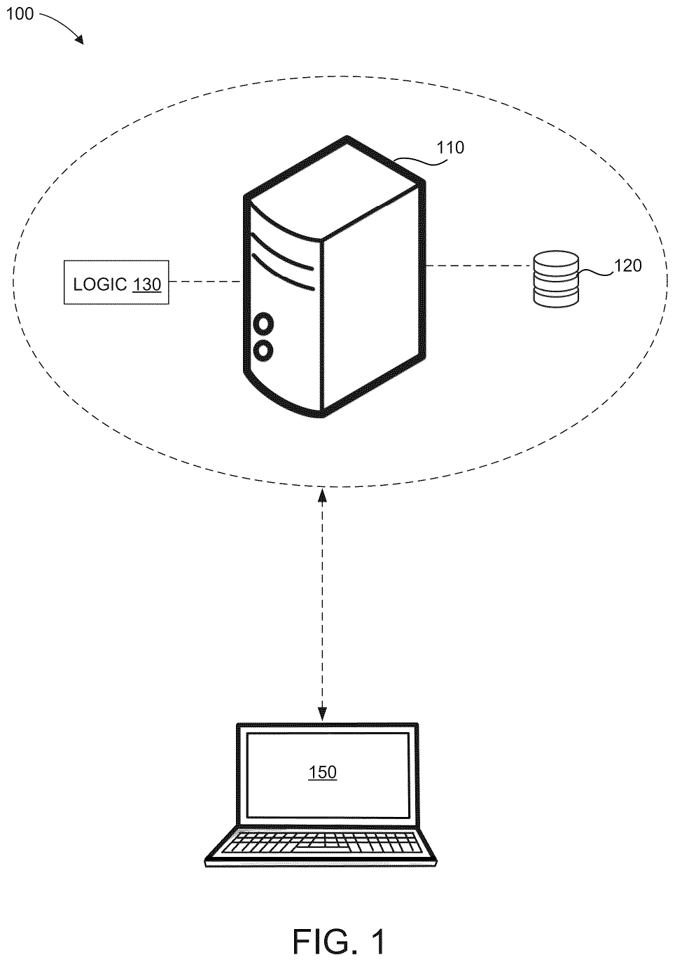

FIG. 1 illustrates an example of a computing system 100 which may be internal or otherwise associated within a device 150. In some applications, the computing system 100 may be a machine learning (ML) pipeline and model, and use ML algorithms. In some examples, the device 150 may be a computing device, such as a desktop computer, a laptop, a mobile phone, a tablet device, an Internet of Things (IoT) device, etc. The device 150 may input data into computing component 110. The computing component 110 may perform one or more available operations on the input data to generate outputs, such as aligning lane connectors and chopping the carriageway into carriageway links. The device 150 may further display the outputs on a GUI on device 150. The GUI on the device 150 may display the outputs as a two dimensional (2D) and three dimensional (3D) layout or map showing the various outputs generated by algorithms, such as ML algorithms, based on various input data, such as mapping structures of carriageways.

The computing system 110 in the illustrated example may include one or more processors and logic 130 that implements instructions to carry out the functions of the computing component 110, for example, selecting a lane connector of a first lane of a carriageway, determining a face of the lane connector, determining a heading of the lane connector at the face, determining a candidate slice to the lane connector at the face, wherein the candidate slice is perpendicular to the heading of the lane connector, determining a second lane connector of a second lane adjacent to the lane connector of the first lane of the carriageway, determining a second candidate slice to the second lane connector at a second face, wherein the second candidate slice is perpendicular to a second heading of the second lane connector, aligning the candidate slice of the lane connector and the second candidate slice of the second lane connector, and chopping the carriageway at the aligned candidate slices. The computing component 110 may store, in a database 120, details regarding scenarios or conditions in which some algorithms, image datasets, and assessments are performed and used to determine lane connectors, faces and headings of lane connectors, and candidate slices, align lane connectors and candidate slices, and chop the carriageway to generate carriageway links. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with device 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and unsupervised depending on the implementation. The ML algorithms may be based on a heuristic approach that more closely mirrors the process described by professional designers. The ML algorithms may emulate the observed characteristics and components of carriageways to better evaluate carriageways and determine components of a carriageway to accurately perform chopping of the carriageway into carriageway links.

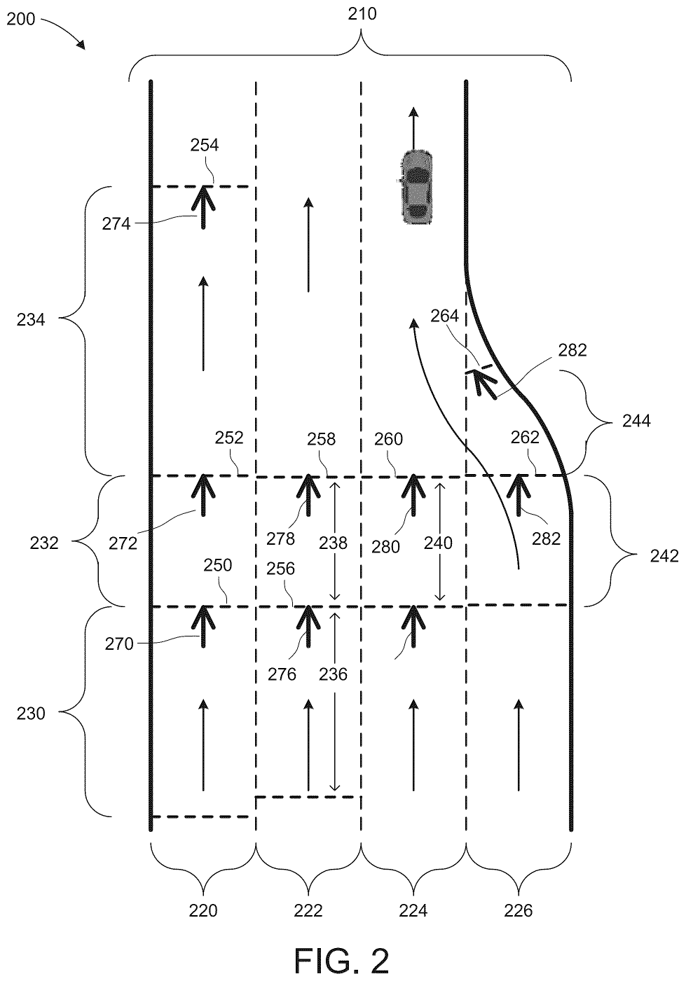

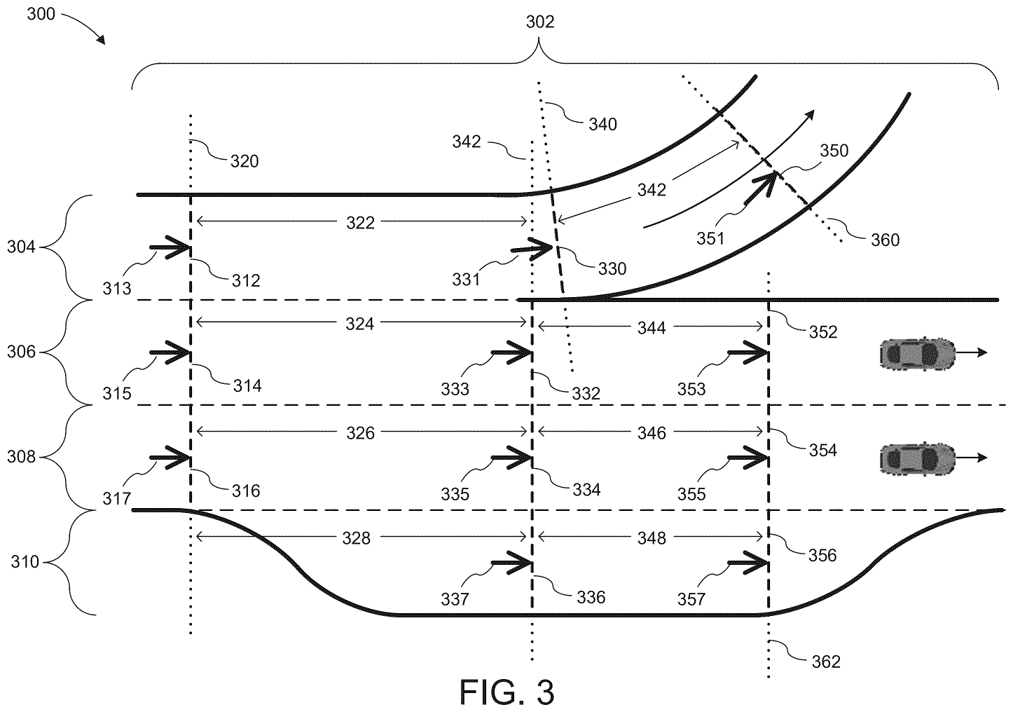

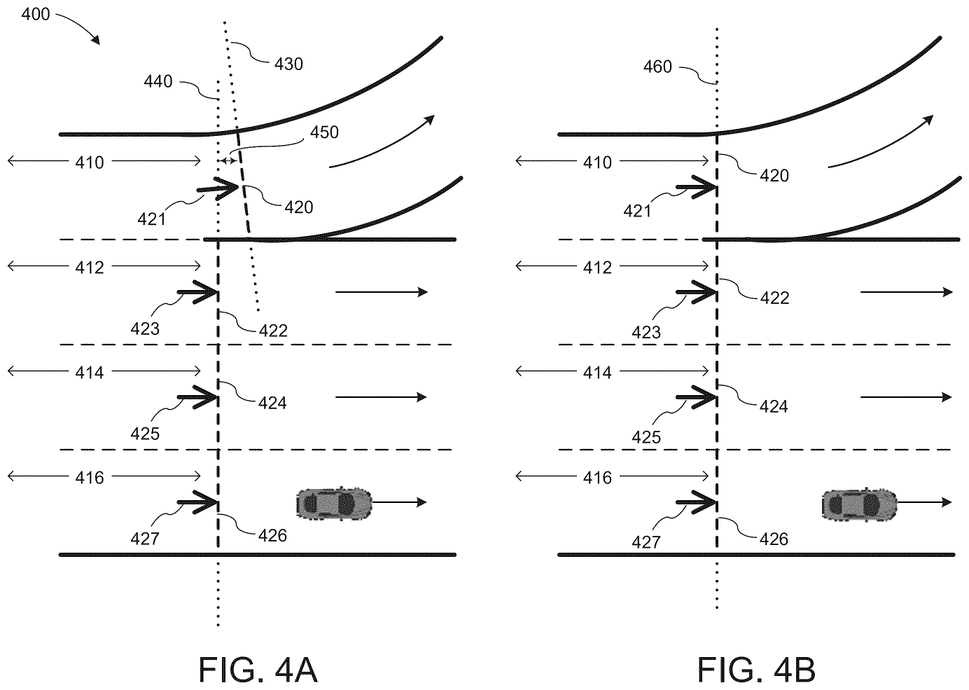

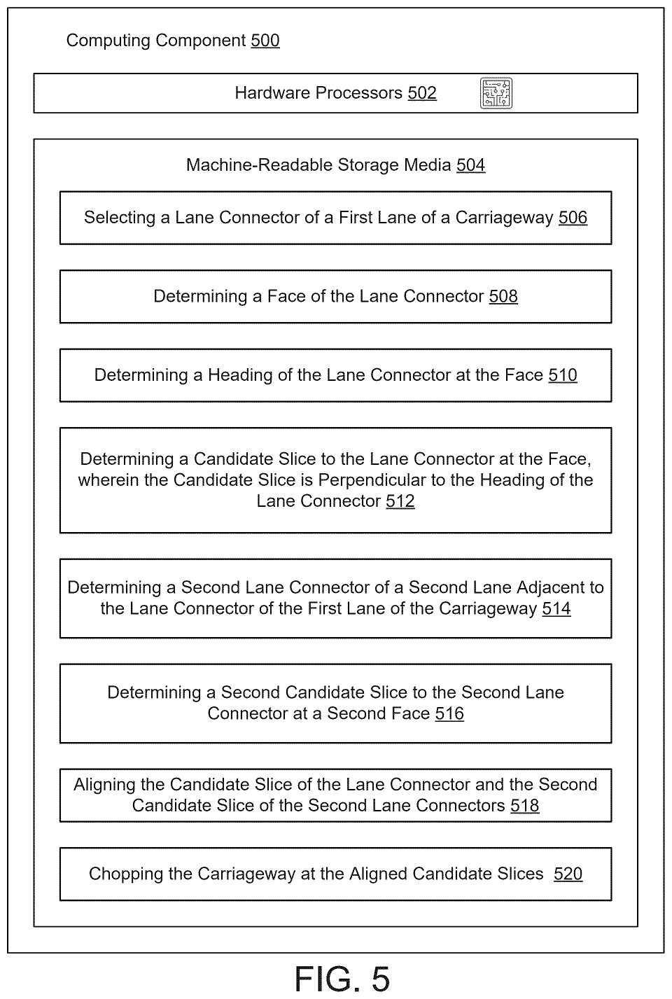

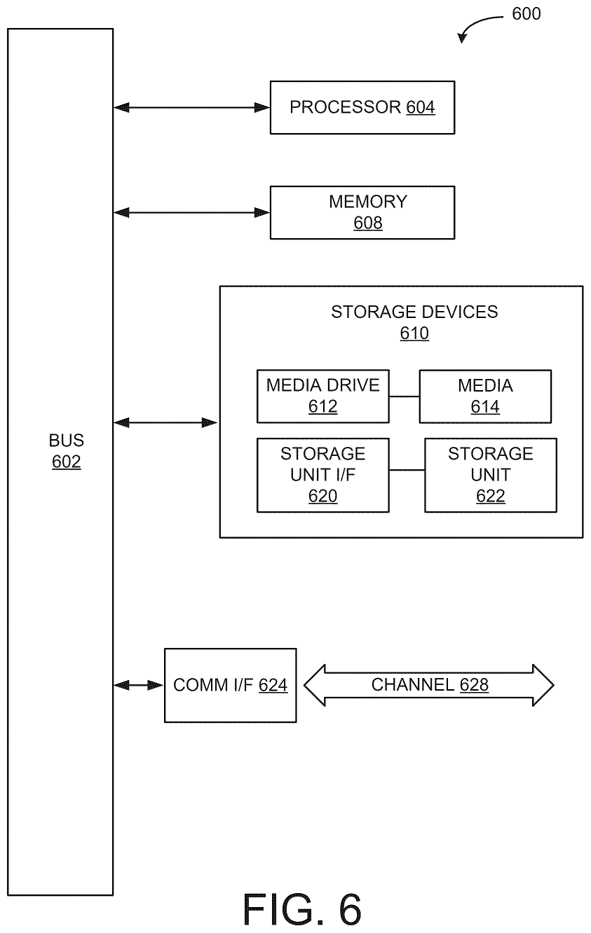

Although one example computing system 110 is illustrated in FIG. 1, in various applications multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components. The computing component 110 may be, for example, the mapping structure system 200 of FIG. 2, the mapping structure system 300 of FIG. 3, the mapping structure system 400 of FIGS. 4A and 4B, the computing component 500 of FIG. 5 and the computing component 600 of FIG. 6.

FIG. 2 illustrates an example of a mapping structure system 200. The mapping structure system 200 may illustrate the mapping structure of one or more carriageways, such as carriageway 210. Carriageway 210 may be a road or pathway that includes a number of lanes used by vehicles, including automobiles, trucks, motorcycles, bicycles, scooters, mopeds, recreational vehicles and other like on- or off-road vehicles. Carriageway 210 may include one or more lanes, such as lanes 220, 222, 224 and 226. Each of the lanes 220, 222, 224 and 226 of the carriageway 210 may be separated by lane markings. A lane of a carriageway may include a traffic lane, a parking lane, an emergency stopping lane, a passing lane and other lane type. The traffic lane may be a lane for vehicular traffic to travel on in a single line in the same direction, including, for example, a straight lane, a merging lane, a branching lane, an off ramp lane, an on ramp lane and a turning lane. For example, lane 226 may be a traffic lane of a merging lane, and lanes 220, 222 and 224 may each be a traffic lane of a straight lane.

Each lane of the carriageway may include a number of lane connectors, with each lane connector representing a different section of a lane of the carriageway. For example, lane 220 of carriageway 210 may include lane connectors 230, 232 and 234, lane 222 may include lane connectors 236 and 238, lane 224 may include lane connector 240, and lane 226 may include lane connectors 242 and 244. Lanes 220, 222, 224 and 226 may include more lane connectors than are illustrated in FIG. 2. Each of lane connectors 230, 232 and 234 may be a different section of lane 220 of carriageway 210.

Each lane connector of a lane of a carriageway, such as lane connectors 230, 232 and 234 of lane 220 of carriageway 210, may be one of a plurality of types of lane connectors. The type of a lane connector may be based on the shape and direction of traffic of the lane connector with respect to other lanes and lane connectors around the same area of the carriageway. The type of a lane connector may be based on whether the lane it is on is a straight lane, a merging lane, a branching lane, an off ramp lane, an on ramp lane, a turning lane, a parking lane, an emergency stopping lane, a passing lane, or other lane type. The type of a lane connector may include, for example, straight, branch left, branch right, left, right, merge left, merge right, loop, loop entry, loop exit and u-turn. For example, lane connectors 230, 232 and 234 of lane 220, lane connectors 236 and 238 of lane 222, lane connector 240 of lane 224 and lane connector 242 of lane 226 may each be a straight type of lane connector. The lane connector 244 of lane 226 may be a merge left type of lane connector.

A lane connector of a lane may be the same or different in length from another lane connector of the same lane. For example, lane connectors 230, 232 and 234 of lane 220 may each be a different length, such as lane connector 230 being 20 feet long, lane connector 232 being 10 feet long and lane connector 234 being 30 feet long. Each lane of a carriageway, such as lanes 220, 222, 224 and 226 of carriageway 210, may have lane connectors that are adjacent to each other, and of similar or the same length. For example, lanes 220, 222, 224 and 226 may have lane connectors 232, 238, 240 and 242, respectively, that are adjacent to each other. The adjacent lane connectors 232, 238, 240 and 242 may all be the same length of 10 feet long. In another example, lanes 220 and 222 may have lane connectors 230 and 236, respectively, that are adjacent to each other, and lane connector 230 may be 20 feet long while lane connector 236 may be 18 feet long. Adjacent lane connectors of the same type may be the same in length. For example, lane connectors 232, 238, 240 and 242 may all be adjacent to each other and the same straight type of lane connector, with each lane connector 232, 238, 240 and 242 being 10 feet long. Many variations are possible.

Each lane connector, such as lane connectors 230, 232, 234, 236, 238, 240, 242 and 244, may include a face, such as face 250, 252, 254, 256, 258, 260, 262 and 264, respectively. The face of a first lane connector may be a line that separates the end of the first lane connector and the beginning of a second, proceeding lane connector of a particular lane of the carriageway. For example, face 250 of lane connector 230 may be a line that separates lane connector 230 and the proceeding lane connector 232 of lane 220, face 252 of lane connector 232 may be a line that separates lane connector 232 and the proceeding lane connector 234 of lane 220, face 254 of lane connector 234 may be a line that separates lane connector 234 and the proceeding lane connector of lane 220, etc.

The location of the face of a lane connector may be determined based on the location where two different types of lane connectors of a particular lane connect. For example, the location of face 262 of lane connector 242 may be determined as the line that connects the straight type lane connector 242 to the merging left type lane connector 244. The location of the face of a lane connector may also be determined based on the location where the number of lanes of the carriageway changes. For example, the location of face 262 of lane connector 242 may be determined because the number of lanes throughout the carriageway 210 is changing from four (4) lanes to three (3) lanes as lane 226 is coming to an end and merging left into lane 224. Lane connectors may be adjacent to each other when the location of their respective faces are within close proximity in longitudinal distance between each other. Close proximity may be when the distance between two objects are within a distance threshold, such as two (2) feet distance, three (3) feet distance, five (5) feet distance, etc. The distance threshold may be preset. The distance threshold may be set according to input data received. The distance threshold may be determined based on algorithms and configurations of the carriageway, the number of lanes of the carriageway, the type of lanes and lane connectors, etc. Many variations are possible.

Each lane connector may include a heading that indicates the direction of traffic that the end of the respective lane connector is directed towards. The heading of a lane connector may be determined according to the direction of traffic at the face of the lane connector. The heading of a lane connector may point towards the face of the lane connector. For example, lane connector 230 may include heading 270 that is pointed towards face 250, lane connector 232 may include heading 272 that is pointed towards face 252, lane connector 234 may include heading 274 that is pointed towards face 254, lane connector 236 may include heading 276 that is pointed towards face 256, lane connector 238 may include heading 278 that is pointed towards face 258, lane connector 240 may include heading 280 that is pointed towards face 260, lane connector 242 may include heading 282 that is pointed towards face 262, etc. The direction of traffic at the end of a lane connector, i.e., the face of the lane connector, may be based on the type of the lane connector. For example, lane connector 244 that is a merging left type of lane connector may have a direction of traffic that is directed towards the left at a 45 degree angle. The heading 282 of lane connector 244 may be determined to be pointed towards the face 264 at a 45 degree angle to the left in the same direction as the direction of traffic. In another example, lane connector 230 that is a straight type of lane connector may have a direction of traffic that is straight forward. The heading 270 of lane connector 230 may be determined to be pointed straight forward towards face 250, in the same direction as the direction of traffic.

The mapping structure system 200 of FIG. 2 may be, for example, the computing component 110 of FIG. 1, the mapping structure system 300 of FIG. 3, the mapping structure system 400 of FIGS. 4A and 4B, the computing component 500 of FIG. 5 and the computing component 600 of FIG. 6. The mapping structure system 200 may include a server.

FIG. 3 illustrates an example of a mapping structure system 300 of a carriageway mapping structure. The carriageway mapping structure may include one or more carriageways, such as carriageway 302. Each carriageway may be a road or pathway that includes a number of lanes used by vehicles, including automobiles, trucks, motorcycles, bicycles, scooters, mopeds, recreational vehicles and other like on- or off-road vehicles. Each carriageway may include one or more lanes, with the lanes separated by lane markings. For example, carriageway 302 may include lanes 304, 306, 308 and 310. A lane of a carriageway may include a traffic lane, a parking lane, an emergency stopping lane, a passing lane and other lane type. The traffic lane may be a lane for vehicular traffic to travel on in a single line in the same direction, including a straight lane, a merging lane, a branching lane, an off ramp lane, an on ramp lane, a turning lane and so on. For example, lane 304 may be a traffic lane of an off ramp lamp, lanes 306 and 308 may each be a traffic lane of a straight lane, and lane 310 may be a passing lane.

Each lane of a carriageway may include a number of lane connectors, with each lane connector representing a different section of a lane of the carriageway. For example, lane 304 may include lane connector 322 and 342, lane 306 may include lane connectors 324 and 344, lane 308 may include lane connectors 326 and 346, lane 310 may include lane connectors 328 and 348, etc. Lanes 304, 306, 308 and 310 may include more lane connectors than are illustrated in FIG. 3. Each lane connector of a lane of a carriageway, such as lane connectors 322, 324, 326, 328, 342, 344, 346 and 348, may be one of a plurality of types of lane connectors. The type of a lane connector may be based on the shape and direction of traffic of the lane connector with respect to other lanes and lane connectors around the same area of the carriageway. The type of a lane connector may be based on whether its respective lane is a straight lane, a merging lane, a branching lane, an off ramp lane, an on ramp lane, a turning lane, a parking lane, an emergency stopping lane or a passing lane. The type of a lane connector may include, for example, straight, branch left, branch right, left, right, merge left, merge right, loop, loop entry, loop exit and u-turn. For example, lane connectors 322 of lane 304, lane connectors 324 and 344 of lane 306, lane connectors 326 and 346 of lane 308, and lane connector 348 of lane 310 may each be a straight type of lane connector. The lane connector 328 of lane 310 may be a branch right type of lane connector. The lane connector 342 of lane 304 may be a branch left type of lane connector.

A lane connector of a lane may be the same or different in length from another lane connector of the same lane. For example, lane connectors 324 and 344 of lane 306 may each be a different length, such as lane connector 324 being 30 feet long and lane connector 344 being 15 feet long. Each lane of a carriageway, such as lanes 304, 306, 308 and 310 of carriageway 302, may have lane connectors that are adjacent to each other, and of similar or the same length. For example, lanes 306, 308 and 310 may have lane connectors 324, 326 and 328, respectively, that are adjacent to each other. The adjacent lane connectors 324, 326 and 328 may all be the same length of 30 feet long. In another example, lanes 304 and 306 may have lane connectors 322 and 324, respectively, that are adjacent to each other, and lane connector 322 may be 35 feet long while lane connector 324 may be 30 feet long. Adjacent lane connectors of the same type may be the same in length. For example, lane connectors 324, 326 and 328 may all be adjacent to each other and the same straight type of lane connector, with each lane connector 324, 326 and 328 being 30 feet long. Many variations are possible.

Each lane connector, such as lane connectors 322, 324, 326, 328, 342, 344, 346 and 348, may include a face, such as faces 330, 332, 334, 336, 350, 352, 354 and 356, respectively. The face of a first lane connector may be a line that separates the end of the first lane connector and the beginning of a second, proceeding lane connector of a particular lane of the carriageway. For example, face 332 of lane connector 324 may be a line that separates lane connector 324 and the proceeding lane connector 344 of lane 306, face 334 of lane connector 326 may be a line that separates lane connector 326 and the proceeding lane connector 346 of lane 308, face 336 of lane connector 328 may be a line that separates lane connector 328 and the proceeding lane connector 348 of lane 310, etc. Lane connectors may be adjacent to each other when the location of their respective faces are within close proximity in longitudinal distance between each other. Close proximity may be when the distance between two objects are within a distance threshold, such as two (2) feet distance, three (3) feet distance, five (5) feet distance, etc. The distance threshold may be preset. The distance threshold may be set according to input data received. The distance threshold may be determined based on algorithms and configurations of the carriageway, the number of lanes of the carriageway, the type of lanes and lane connectors, etc. Many variations are possible.

The location of the face of a lane connector may be determined based on the location where two different types of lane connectors of a particular lane connect. For example, the location of face 356 of lane connector 348 may be determined as the line that connects the straight type lane connector 348 to the proceeding, merging left type lane connector of lane 310. The location of the face of a lane connector may also be determined based on the location where the number of lanes of the carriageway changes. For example, the location of face 316 may be determined because the number of lanes throughout the carriageway 302 is changing from three (3) lanes to four (4) lanes as lane 310 is being added and branching right from lane 308.

Each lane connector may include a heading that indicates the direction of traffic that the end of the respective lane connector is directed towards. The heading of a lane connector may be determined according to the direction of traffic at the face of the lane connector. The heading of a lane connector may point towards the face of the lane connector. For example, lane connector 322 may include heading 331 that is pointed towards face 330, lane connector 324 may include heading 333 that is pointed towards face 332, lane connector 326 may include heading 335 that is pointed towards face 334, lane connector 328 may include heading 337 that is pointed towards face 336, lane connector 342 may include heading 351 that is pointed towards face 350, lane connector 344 may include heading 353 that is pointed towards face 352, lane connector 346 may include heading 355 that is pointed towards face 354, lane connector 348 may include heading 357 that is pointed towards face 356, etc. The direction of traffic at the end of a lane connector, i.e., the face of the lane connector, may be based on the type of the lane connector. For example, lane connector 342 that is a branch left type of lane connector in an off ramp lane may have a direction of traffic that is directed towards the left of the carriageway at a 45 degree angle. The heading 351 of lane connector 342 may be determined to be pointed towards the face 350 at a 45 degree angle to the left in the same direction as the direction of traffic. In another example, lane connector 324 that is a straight type of lane connector may have a direction of traffic that is straight forward. The heading 333 of lane connector 324 may be determined to be pointed straight forward towards face 332, in the same direction as the direction of traffic.

Using the heading of a lane connector of a lane, a candidate slice of the lane may be determined at the face of the lane connector, i.e., at the end of the lane connector. A candidate slice of a lane of a carriageway may be a line that goes through the entire lane at a face of a lane connector, such as candidate slices 320, 340, 342, 360 and 362. A candidate slice may be determined at each face of each lane connector of each lane of a carriageway. Each lane of a carriageway may include one or more candidate slices. When lane connectors have respective candidate slices that are positioned along the same latitudinal axis across the carriageway, such candidate slices may be combined for simplicity purposes. Each candidate slice across the carriageway may be used as a marker of where the carriageway may be chopped to create one or more carriageway links.

A candidate slice of a lane connector may be determined based on the direction of the heading of the lane connector at the face. The candidate slice of a lane connector may be a line that is perpendicular to the heading of the lane connector at the face. For example, lane 304 may include a lane connector that has face 312 and heading 313. Based on the direction of heading 313, candidate slice 320 may be determined as it may be a line perpendicular to the heading 313 that goes through the entire lane 304. The individual candidate slices of the lane connectors with respective faces 314 and 316 may also be positioned along the same latitudinal axis across the carriageway 302. The individual candidate slices of the lane connectors at faces 314 and 316 may be combined with candidate slice 320 for simplicity reasons. Candidate slice 320 may now be the candidate slice for the three lane connectors at their respective faces 312, 314 and 316.

In another example, lane connectors 322, 324, 326 and 328 may have faces 330, 332, 334 and 336, and headings 331, 333, 335 and 337, respectively. Each of lane connectors 322, 324, 326 and 328 may have a candidate slice according to their respective headings 331, 333, 335 and 337. Given that the faces 332, 334 and 336 of lane connectors 324, 326 and 328, respectively, may be positioned along the same latitudinal axis across the carriageway 302 and the headings 333, 335 and 337 being positioned in the same direction with lane connectors 324, 326 and 328 being the same straight forward type of a lane connector, the lane connectors 324, 326 and 328 may all have respective candidate slices that are along the same latitudinal axis across the carriageway 302. The respective candidate slices of lane connectors 324, 326 and 328 may be combined for simplicity purposes, such that candidate slice 342 is used for lane connectors 324, 326 and 328. Lane connector 322 may have its own candidate slice 340 because it may have a face 330 that is located at a different position on the carriageway from the latitudinal axis across the carriageway 302 where faces 332, 334 and 336 are positioned, and the heading 331 may be positioned in a different direction from headings 333, 335 and 337, as the direction of traffic at face 330 of lane connector 322 may be different from the direction of traffic at faces 332, 334 and 336 of lane connectors 324, 326 and 328, respectively. Many variations are possible.

The mapping structure system 300 of FIG. 3 may be, for example, the computing component 110 of FIG. 1, the mapping structure system 200 of FIG. 2, the mapping structure system 400 of FIGS. 4A and 4B, the computing component 500 of FIG. 5 and the computing component 600 of FIG. 6. The computing component 110 may include a server.

FIGS. 4A and 4B illustrate an example illustration of a mapping structure system 400. The mapping structure system 400 may illustrate the mapping structure of a carriageway at a particular location where the number of lanes of the carriageway is changing. In FIG. 4A, the mapping structure system 400 may further illustrate the mapping structure of a carriageway at a particular location where there are adjacent lane connectors 410, 412, 414 and 416, with adjacent lane connectors 412, 414 and 416 each having the same candidate slice 440 and the adjacent lane connector 410 having a different candidate slice 430. Lane connector 410 may have a different candidate slice 430 from adjacent lane connectors 412, 414 and 416 because lane connector 410 is of a different length than adjacent lane connectors 412, 414 and 416. Lane connector 410 may have a different candidate slice 430 from adjacent lane connectors 412, 414 and 416 because lane connector 410 is of a different type of lane connector than adjacent lane connectors 412, 414 and 416. Lane connector 410 may have a different candidate slice 430 from adjacent lane connectors 412, 414 and 416 because lane connector 410 has face 420 that is positioned along a different latitudinal axis on the carriageway than faces 422, 424 and 426 of lane connectors 412, 414 and 416, respectively. Lane connector 410 may have a different candidate slice 430 from adjacent lane connectors 412, 414 and 416 because lane connector 410 has heading 421 positioned in a direction that is different from the direction of headings 423, 425 and 427 of lane connectors 412, 414 and 416, respectively.

When a lane connector, such as lane connector 410, has a candidate slice that is oriented and positioned latitudinally across the carriageway differently from the candidate slice(s) of adjacent lane connectors, such as lane connectors 412, 414 and 416, it may be determined if the candidate slice of one or more lane connectors may be moved to align the candidate slices of each adjacent lane connector. Moving a candidate slice of a lane connector may include moving the face of the lane connector to a new position to cause the heading of the lane connector to be positioned in a new direction. The face and heading of one or more lane connectors may be moved to new positions until the faces of each adjacent lane connector is positioned along the same latitudinal axis across the carriageway and the heading of each adjacent lane connector is positioned in the same direction along the carriageway. If there are a plurality of lane connectors with respective candidate slices positioned along the same latitudinal axis across the carriageway, then the lane connector(s) with a differently positioned candidate slice(s) may be moved to align the differently positioned candidate slice(s) with the other same candidate slices. After the respective candidate slices of one or more lane connectors have been moved and all of the candidate slices of the adjacent lane connectors are aligned, all of the candidate slices may be combined into one candidate slice, for simplicity purposes.

A first candidate slice of a first lane connector may be moved to the position of a second candidate slice of an adjacent lane connector when the first candidate slice is in close proximity of the second candidate slice. For candidate slices to be in close proximity of each other, the longitudinal distance between the candidate slices may be within a distance threshold. The distance threshold may be a preset value, such as two (2) feet, three (3) feet, five (5) feet, etc. The distance threshold may vary according to one or more variables, such as the carriageway, the number of lanes at a particular location of the carriageway, the type of each adjacent lane connector, etc. One or more algorithms may be used to determine the distance threshold of the carriageway and evaluate whether the longitudinal distance between candidate slices are in close proximity.

For example, in FIG. 4A, the longitudinal distance 450 between candidate slice 430 and candidate slice 440 may be three (3) feet. The distance threshold of the carriageway may be determined to be five (5) feet. With the longitudinal distance between candidate slices 430 and 440 being within the distance threshold, the candidate slices 430 and 440 may be determined to be in close proximity. The mapping structure system 400 may then select to move candidate slice 430 or candidate 440 to align the candidate slices. With candidate slice 440 being used for lane connectors 412, 414 and 416, and candidate slice 430 only being used for lane connector 410, the mapping structure system 400 may select to only move candidate slice 430.

In FIG. 4B, the candidate slice 430 of lane connector 410 is moved to the left to be aligned with the candidate slice 440 of lane connectors 412, 414 and 416. Moving the candidate slice 430 of lane connector 410 includes moving face 420 such that face 420 is positioned along the same latitudinal axis across the carriageway as faces 422, 424 and 426 of lane connectors 412, 414 and 416, respectively. Moving the candidate slice 430 of lane connector 410 also includes moving heading 421 to a position where heading 421 is positioned in the same direction along the carriageway as headings 423, 425 and 427 of lane connectors 412, 414 and 416, respectively. After candidate slice 430 of lane connector 410 is moved to be aligned with the candidate slice 440 of lane connectors 412, 414 and 416 on the same latitudinal axis across the carriageway, the candidate slices 430 and 440 may be combined into candidate slice 460. Candidate slice 460 may be used for all of the adjacent lane connectors 410, 412, 414 and 416.

After candidate slices of a carriageway are finalized, i.e., after the mapping structure system 400 has evaluated, moved and aligned candidate slices of various lane connectors, the mapping structure system 400 may chop the carriageway along each of the finalized candidate slices. Chopping the carriageway may include performing a slice through the carriageway to separate the carriageway into two sections. The carriageway may be chopped at each finalized candidate slice to create a plurality of sections of the carriageway.

A section of a carriageway that is between two chops of the carriageway may be a carriageway link. Carriageway links of the carriageway may be generated to sectionalize the carriageway into sections where each carriageway link contains a consistent number of lanes of the carriageway throughout. Carriageway links may be generated between the chops at each finalized candidate slice of the carriageway. As an example, in FIG. 3, a carriageway link of a carriageway may be the combination of link connectors 344, 346 and 348 of carriageway 302, between chops performed at the finalized candidate slices 342 and 362. The carriageway link of the combination of link connectors 344, 346 and 348 of carriageway 302 may illustrate a section of the carriageway 302 where the number of lanes of three (3) remains the same throughout the carriageway.

As alluded to above, a carriageway may include a plurality of carriageway links based on the number of finalized candidate slices that are determined on the carriageway. Each carriageway link may vary in length based on the distance between the finalized candidate slices where the two chops are made to create each carriageway link. Each carriageway link may vary in the number of lanes it includes, with each carriageway link representing a different section of the carriageway and each carriageway link having a consistent number of lanes throughout. Carriageway links may be used to accurately performing the mapping, construction and repair of a carriageway as a whole by individually evaluating different sections of the carriageway at a particular time. The mapping structure system 400 may use ML algorithms and models to accurately evaluate components of a carriageway, such as lanes, lane connectors, types of lane connectors, faces, headings and candidate slices of lane connectors, etc., accurately perform the chopping of carriageways, and generate carriageway links accurately and efficiently. The mapping structure system 400 of FIGS. 4A and 4B, may be, for example, the computing component 110 of FIG. 1, the mapping structure system 200 of FIG. 2, the mapping structure system 300 of FIG. 3, the computing component 500 of FIG. 5 and the computing component 600 of FIG. 6.

FIG. 5 illustrates an example computing component 500 that includes one or more hardware processors 502 and machine-readable storage media 504 storing a set of machine-readable/machine-executable instructions that, when executed, cause the hardware processor(s) 502 to perform an illustrative method of carriageway chopping in mapping structures using algorithms in a heuristic approach. It should be appreciated that there can be additional, fewer, or alternative steps performed in similar or alternative orders, or in parallel, within the scope of the various examples discussed herein unless otherwise stated. The computing component 500 may be implemented as the computing component 110 of FIG. 1, the mapping structure system 200 of FIG. 2, the mapping structure system 300 of FIG. 3, the mapping structure system 400 of FIG. 4 and the computing component 600 of FIG. 6. FIG. 5 summarizes and further elaborates on some aspects previously described.

At step 506, the hardware processor(s) 502 may execute machine-readable/machine-executable instructions stored in the machine-readable storage media 504 to select a lane connector of a first lane of a carriageway. The carriageway may be a road or pathway that includes a number of lanes used by vehicles, including automobiles, trucks, motorcycles, bicycles, scooters, mopeds, recreational vehicles and other like on- or off-road vehicles. Each lane of the carriageway may be separated by lane markings. Each lane of the carriageway may include a number of lane connectors, with each lane connector representing a different section of a lane of the carriageway. The lane connectors of a lane of the carriageway may include, for example, a traffic lane, a parking lane, an emergency stopping lane and a passing lane. The traffic lane may be a lane for vehicular traffic to travel on in a single line in the same direction, including a straight lane, a merging lane, a branching lane, an off ramp lane, an on ramp lane, a turning lane and so on.

At step 508, the hardware processor(s) 502 may execute machine-readable/machine-executable instructions stored in the machine-readable storage media 504 to determine a face of the lane connector. Each lane connector of a lane of a carriageway may be one of a plurality of types of lane connectors. The type of a lane connector may be based on the shape and direction of traffic of the lane connector with respect to other lanes and lane connectors around the same area of the carriageway. The type of a lane connector may be based on whether its respective lane is a straight lane, a merging lane, a branching lane, an off ramp lane, an on ramp lane, a turning lane, a parking lane, an emergency stopping lane, a passing lane or other lane type. The type of a lane connector may include, for example, straight, branch left, branch right, left, right, merge left, merge right, loop, loop entry, loop exit and u-turn.

The face of the lane connector may be determined based on the type of the lane connector. The face of the lane connector may be determined based on the location where two different types of lane connectors of a particular lane connect. The face of the lane connector may be determined based on the location where the number of lanes of the carriageway changes. The face of the lane connector may be a line that separates the end of the lane connector and the beginning of a second lane connector of a particular lane of the carriageway.

At step 510, the hardware processor(s) 502 may execute machine-readable/machine-executable instructions stored in the machine-readable storage media 504 to determine a heading of the lane connector at the face. Each lane connector may have a heading that indicates the direction of traffic that the end of the respective lane connector is directed towards. A heading of the lane connector may be determined to be the direction of traffic of the lane connector at the face.

At step 512, the hardware processor(s) 502 may execute machine-readable/machine-executable instructions stored in the machine-readable storage media 504 to determine a candidate slice to the lane connector at the face, wherein the candidate slice is perpendicular to the heading of the face connector. The face of the lane connector may be a line that separates the end of the lane connector and the beginning of another lane connector of a particular lane of the carriageway. A candidate slice may be determined to be at the end of the lane connector at the location of the face. The candidate slice may be a line that goes through the entire lane at the face of the lane connector. The candidate slice may be determined based on the direction of the heading of the lane connector at the face. The candidate slice may be a line that is perpendicular to the heading of the lane connector at the face.

At step 514, the hardware processor(s) 502 may execute machine-readable/machine-executable instructions stored in the machine-readable storage media 504 to determine a second lane connector of a second lane adjacent to the lane connector of the first lane of the carriageway. The carriageway may include a number of lanes, including the first lane and the second lane, that are adjacent to each other and directing traffic in the same direction. Each adjacent lane of the carriageway may include a number of respective lane connectors. The lane connectors of the first lane may be adjacent to the lane connectors of the second lane. The second lane connector of the second lane of the carriageway may be determined to be adjacent to the lane connector of the first lane of the carriageway when the first lane and second lane are adjacent to each other, and the lane connector and second lane connector are also adjacent to each other. The lane connector and second lane connector may be adjacent to each other when the face of the lane connector of the first lane is in close proximity to a second face of the second lane connector of the second lane. Close proximity may be when the distance between two objects are within a distance threshold.

At step 516, the hardware processor(s) 502 may execute machine-readable/machine-executable instructions stored in the machine-readable storage media 504 to determine a second candidate slice to the second lane connector at a second face. The second face of the second lane connector may be a line that separates the end of the second lane connector and the beginning of a different lane connector of the second lane of the carriageway. The second candidate slice may be determined to be at the end of the second lane connector at the location of the second face. The second candidate slice may be a line that goes through the entire second lane at the second face of the second lane connector. The second candidate slice may be determined based on the direction of a second heading of the second lane connector at the second face. The second heading of the second lane connector may be determined to be the direction of traffic of the second lane connector at the second face. The second candidate slice may be a line that is perpendicular to the second heading of the second lane connector at the second face.

At step 518, the hardware processor(s) 502 may execute machine-readable/machine-executable instructions stored in the machine-readable storage media 504 to align the candidate slice of the lane connector and the second candidate slice of the second lane connector. Lane connectors of different lanes of a carriageway, such as the lane connector of the first lane and the second lane connector of the second lane, may be adjacent to each other based on the location of their respective faces. Each adjacent lane connector may have a candidate slice at their respective faces, such as the candidate slice of the lane connector and the second candidate slice of the second lane connector. The candidate slice of each adjacent lane connector may be located according to the heading of the respective lane connector.

Aligning the candidate slices of adjacent lane connectors may be performed when the candidate slices are in close proximity of each other. For candidate slices of adjacent lane connectors, such as the candidate slice of the lane connector and the second candidate slice of the second lane connector, to be in close proximity of each other, it may be determined that a longitudinal distance between the candidate slices may be within a distance threshold. The distance threshold may be a preset value. The distance threshold may vary according to one or more algorithms. When it is determined that the longitudinal distance between the candidate slices of adjacent lane connectors are in close proximity of each other, the candidate slices may be aligned by moving one or more faces of the adjacent lane connectors until the position of the heading of each adjacent lane connector is in the same direction and the candidate slice of each lane connector are on the same latitudinal line across the carriageway.

At step 520, the hardware processor(s) 502 may execute machine-readable/machine-executable instructions stored in the machine-readable storage media 504 to chop the carriageway at the aligned candidate slices. After the candidate slices of adjacent lane connectors are aligned, the carriageway may be chopped at the aligned candidate slices. Each aligned candidate slice of a carriageway may be located where the number of lanes of the carriageway is changing, i.e., from one lane to two lanes, two lanes to four lanes, four lanes to three lanes, three lanes to five lanes, etc. Chopping the carriageway may include performing a slice through the carriageway to separate the carriageway into two sections. The carriageway may be chopped at each aligned candidate slice to create a plurality of sections of the carriageway.

A section of a carriageway that is between two chops of the carriageway may be a carriageway link. Carriageway links of the carriageway may be generated to sectionalize the carriageway into sections where each carriageway link contains a consistent number of lanes of the carriageway throughout. Carriageway links may be generated between the chops at each aligned candidate slice of the carriageway.

Subsequently, the hardware processor(s) 502 may determine subsequent data of additional adjacent lane connectors of the carriageway and repeat the aforementioned steps for each of the additional adjacent lane connectors determined, until no additional adjacent lane connectors of the carriageway are determined.

As used herein, the terms circuit and component might describe a given unit of functionality that can be performed in accordance with one or more applications of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various applications are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and any one or more of the components making up device 150 of FIG. 1 and computing system of mapping structure 200 of FIG. 2. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative applications, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual applications are not limited in their applicability to the particular application with which they are described. Instead, they can be applied, alone or in various combinations, to one or more other applications, whether or not such applications are described and whether or not such features are presented as being a part of a described application. Thus, the breadth and scope of the present application should not be limited by any of the above-described exemplary applications.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computing system for carriageway chopping in a mapping structure comprising:
one or more processors; and
memory coupled to the one or more processors to store instructions, which when executed by the one or more processors, cause the one or more processors to perform operations, the operations comprising:
determining a face of a lane connector of a first lane of a carriageway;
determining a heading of the lane connector at the face;
determining a candidate slice to the lane connector at the face;
determining a second candidate slice to a second lane connector of a second lane at a second face;
aligning the candidate slice of the lane connector and the second candidate slice of the second lane connector; and
chopping the carriageway at the aligned candidate slices.

2. The computing system of claim 1, wherein the lane connector comprises at least one of a merging lane, a branching lane, an off ramp lane, an on ramp lane, a straight lane, a parking lane and a turning lane.

3. The computing system of claim 1, wherein the determining the face of the lane connector comprises:
determining a type of the lane connector; and
determining the face of the lane connector according to the type.

4. The computing system of claim 3, wherein the type of the lane connector comprises at least one of branch left, branch right, left, right, merge left, merge right, loop, loop entry, loop exit, straight and u-turn.

5. The computing system of claim 1, wherein the heading of the lane connector at the face is indicative of the direction of traffic at the end of the lane connector.

6. The computing system of claim 1, wherein the aligning the candidate slice of the lane connector and the second candidate slice of the second lane connector comprises:
determining a longitudinal distance between the second candidate slice to the second lane connector and the candidate slice to the lane connector;
determining the longitudinal distance is within a distance threshold; and
aligning the candidate slices of the lane connectors by moving the face of the lane connector or the second face of the second lane connector to position the heading of each lane connector in the same direction and the candidate slice of each lane connector on the same latitudinal line across the carriageway.

7. The computing system of claim 1, the operations further comprise generating a carriageway link between two chops of the carriageway, wherein the carriageway link between the two chops includes a consistent number of lanes of the carriageway throughout.

8. The computing system of claim 1, wherein the candidate slice is perpendicular to the heading of the lane connector.

9. The computing system of claim 1, wherein the second lane connector of the second lane is adjacent to the lane connector of the first lane of the carriageway.

10. A method for carriageway chopping in a mapping structure, the method comprising:
determining a face of a lane connector of a first lane of a carriageway;
determining a heading of the lane connector at the face;
determining a candidate slice to the lane connector at the face;
determining a second candidate slice to a second lane connector of a second lane at a second face;
aligning the candidate slice of the lane connector and the second candidate slice of the second lane connector; and
chopping the carriageway at the aligned candidate slices.

11. The method of claim 10, wherein the lane connector comprises at least one of a merging lane, a branching lane, an off ramp lane, an on ramp lane, a straight lane, a parking lane and a turning lane.

12. The method of claim 10, the determining the face of the lane connector comprises:
determining a type of the lane connector; and
determining the face of the lane connector according to the type.

13. The method of claim 12, wherein the type of the lane connector comprises at least one of branch left, branch right, left, right, merge left, merge right, loop, loop entry, loop exit, straight and u-turn.

14. The method of claim 10, wherein the heading of the lane connector at the face is indicative of the direction of traffic at the end of the lane connector.

15. The method of claim 10, wherein the aligning the candidate slice of the lane connector and the second candidate slice of the second lane connector comprises:
determining a longitudinal distance between the second candidate slice to the second lane connector and the candidate slice to the lane connector;
determining the longitudinal distance is within a distance threshold; and
aligning the candidate slices of the lane connectors by moving the face of the lane connector or the second face of the second lane connector to position the heading of each lane connector in the same direction and the candidate slice of each lane connector on the same latitudinal line across the carriageway.

16. The method of claim 10, further comprising:
generating a carriageway link between two chops of the carriageway, wherein the carriageway link between the two chops includes a consistent number of lanes of the carriageway throughout.

17. The method of claim 11, wherein the candidate slice is perpendicular to the heading of the lane connector.

18. The method of claim 11, wherein the second lane connector of the second lane is adjacent to the lane connector of the first lane of the carriageway.

19. A non-transitory machine-readable medium having instructions stored therein, which when executed by a processor, cause the processor to perform operations, the operations comprising:
determining a face of a lane connector of a first lane of a carriageway;
determining a heading of the lane connector at the face;
determining a candidate slice to the lane connector at the face;
determining a second candidate slice to a second lane connector of a second lane at a second face;
aligning the candidate slice of the lane connector and the second candidate slice of the second lane connector; and
chopping the carriageway at the aligned candidate slices.

20. The non-transitory machine-readable medium of claim 19, wherein the aligning the candidate slice of the lane connector and the second candidate slice of the second lane connector comprises:
determining a longitudinal distance between the second candidate slice to the second lane connector and the candidate slice to the lane connector;
determining the longitudinal distance is within a distance threshold, wherein the close proximity is a distance between the candidate slices within a distance threshold; and
aligning the candidate slices of the lane connectors by moving the face of the lane connector or the second face of the second lane connector to position the heading of each lane connector in the same direction and the candidate slice of each lane connector on the same latitudinal line across the carriageway.
